(19) United States
(12) Patent Application Publication
(10) Pub. No.: US 2006/0077338 A1
(43) Pub. Date: Apr. 13, 2006

(54) Composite frame for spectacles

(75) Inventor: Shao-Chang Tang, Taipei (TW)

Correspondence Address: TROXELL LAW OFFICE PLLC, SUITE 1404, 5205 LEESBURG PIKE, FALLS CHURCH, VA, 22041, US

(73) Assignee: Optiunion Co., Ltd.

(21) Appl. No.: 10/959,155

(22) Filed: Oct. 7, 2004

(51) Int. Cl. G02C 1/08

(52) U.S. Cl. 351/90

(57) ABSTRACT

A composite frame for spectacles includes two fronts, a bridge, a pair of nose brackets, two coupling modules and two temples. Each of the fronts has two sides extended transversely to form a first pin and a second pin. The bridge has two transverse ends each has a first cavity to hold the first pin. The coupling modules have respectively a second cavity on one side to hold the second pin and other side pivotally coupled with the temple. The elements of the frame may be fabricated separately and coupled through pins or insertion. Assembly and repairs are easier. The style and color of the fronts may be altered as desired.

### BACKGROUND OF THE INVENTION

1. Field of the Invention

The invention relates to a frame of spectacles and particularly to a composite frame of spectacles formed with few or no soldering structure and being able to be assembled in varying shapes and colors.

2. Description of the Prior Art

Refer to FIG. 1 for the conventional full frame spectacles. It has two lenses 90 coupled on two fronts 91 of a frame 9. The two fronts 91 are connected by a bridge 92. Each of the fronts 91 has one end remote from the bridge 92 to couple with a temple 93. The bridge 92 has two ends abutting the fronts 91 to couple with a nose bracket 94. To facilitate storing, the temple 93 includes a foldable stem 932 to pivotally couple with a bending arm 931 which is soldered on the front 91.

If the frame 9 is made of metal, the fronts 91, bridge 92 and bending arm 931 are fabricated separately and soldered together. Then they are trimmed, plated or coated with paint on the surface. As the frame is integrally formed by soldering, the most economical way is to coat only one color on the surface. To coat different colors on different locations makes fabrication process more complicated and costly. Moreover, the soldering areas on the fronts 91, bridge 92 and bending arm 931 are very small. Soldering is difficult and the structural strength of finished product is affected. This is especially true on the juncture of the bending arm 931 and the fronts 91, as it has to endure frequent bending forces during adjustment. The nose bracket 94 also often encounters unpredictable impact of external forces. All this easily causes structural damage. It the past, whenever a fracture occurs to frame of the spectacles, it has to be sent to the plant for soldering, and cannot be repaired at the general eyeglasses shop. The total repair time for sending the spectacles to the plant is lengthy and results in a lot of inconvenience to users.

Moreover, the conventional spectacles frame fabricated by soldering has the fronts integrally formed in an annular fashion. Different types of fronts have to be fabricated by different molds. The fabrication cost is higher. They also are not compatible and cannot be interchanged among different types of fronts.

### SUMMARY OF THE INVENTION

In view of the aforesaid problems occurred to the conventional spectacles frame, the present invention aims to provide a novel spectacles frame that is fabricated with few or even no soldering. Fabrication process is simple and assembly is easy. Moreover, the spectacles frame according to the invention adopts a modular structure that may be assembled flexibly to form varying styles as desired.

The composite frame of spectacles according to the invention mainly includes two fronts, a bridge, a pair of nose brackets, two coupling modules and two temples. Each of the fronts has a pin extended respectively and transversely from two sides. The bridge has two transverse ends each having a cavity to receive one pin of the fronts. The other pin of the fronts is inserted into another cavity formed on one side of the coupling modules. The coupling modules have other side pivotally coupled with the temple. Thus the elements of the spectacles frame may be fabricated separately and coupled through pins or insertion. Therefore there is no need to do the troublesome soldering of the conventional techniques. Assembly is easier. Moreover, repairs can be done by disassembling the individual elements, and replacement can be made in the general eyeglasses shop. Thus repair time is shortened greatly.

In another aspect, the elements according to the invention may be coated with different colors. Then different elements may be coupled and assembled to form a spectacles frame with rich color combinations and selections. The front may also include a upper rim and a lower rim that are separable. The upper rim and the lower rim may be formed in different shapes and be flexibly coupled to form varying styles of frames. Thus many different styles of frames may be formed at a lower molding cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional spectacles with a frame;

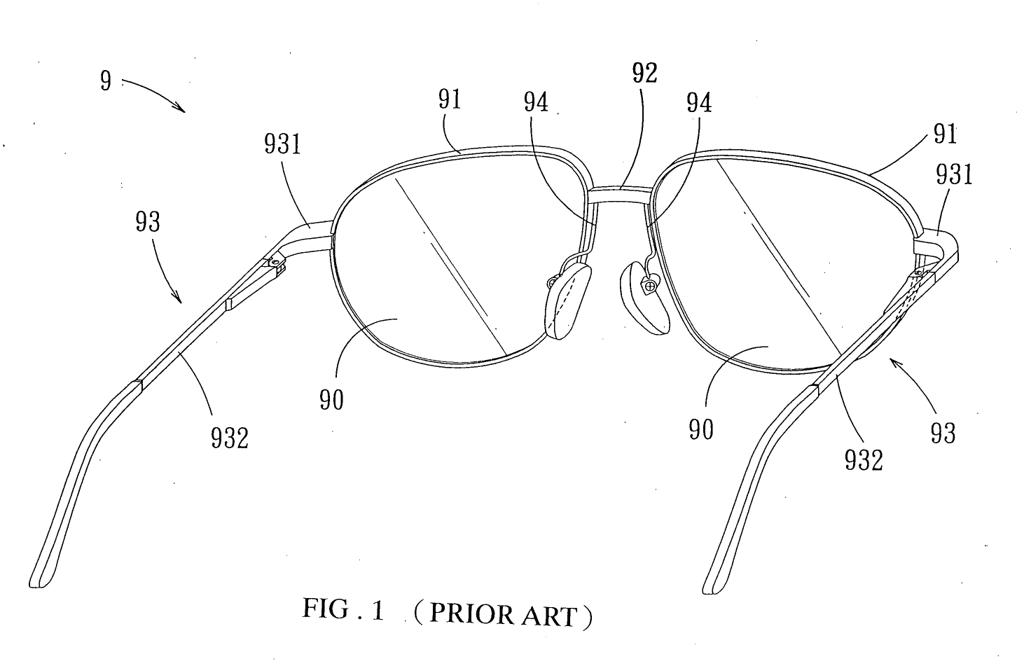

FIG. 2 is a perspective view of a first embodiment of the composite spectacles frame of the invention;

FIG. 3 is an exploded view according to FIG. 2;

FIG. 4 is a fragmentary schematic view of a second embodiment of the composite spectacles frame of the invention; and

FIGS. 5A through 5D are schematic views of various embodiments of the front assembly according to the invention.

### DESCRIPTION OF THE PREFERRED EMBODIMENTS

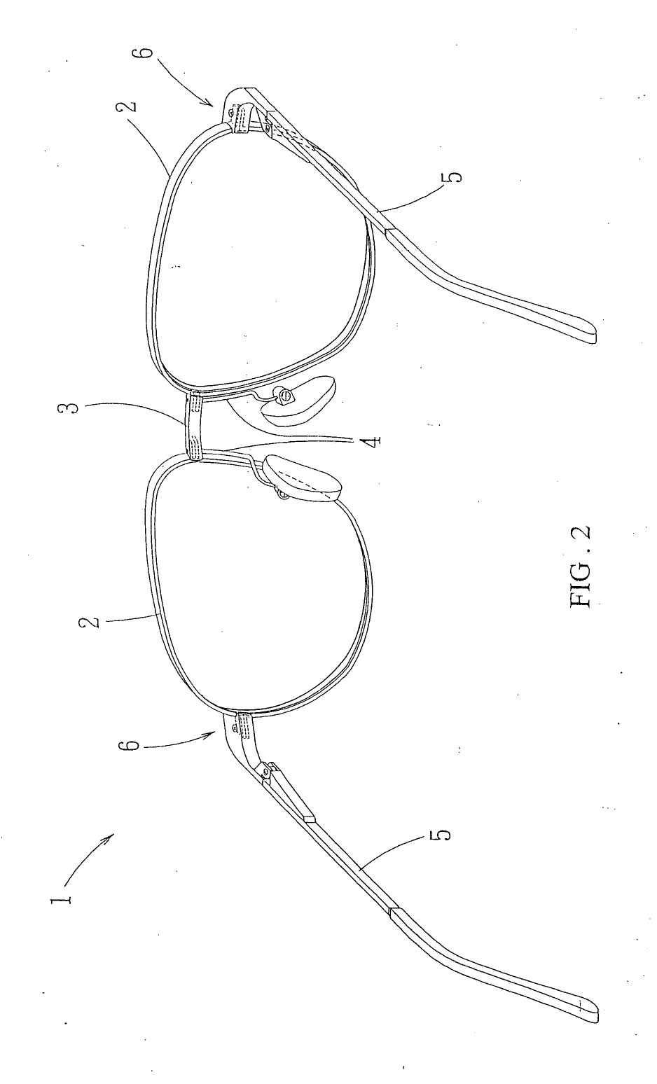

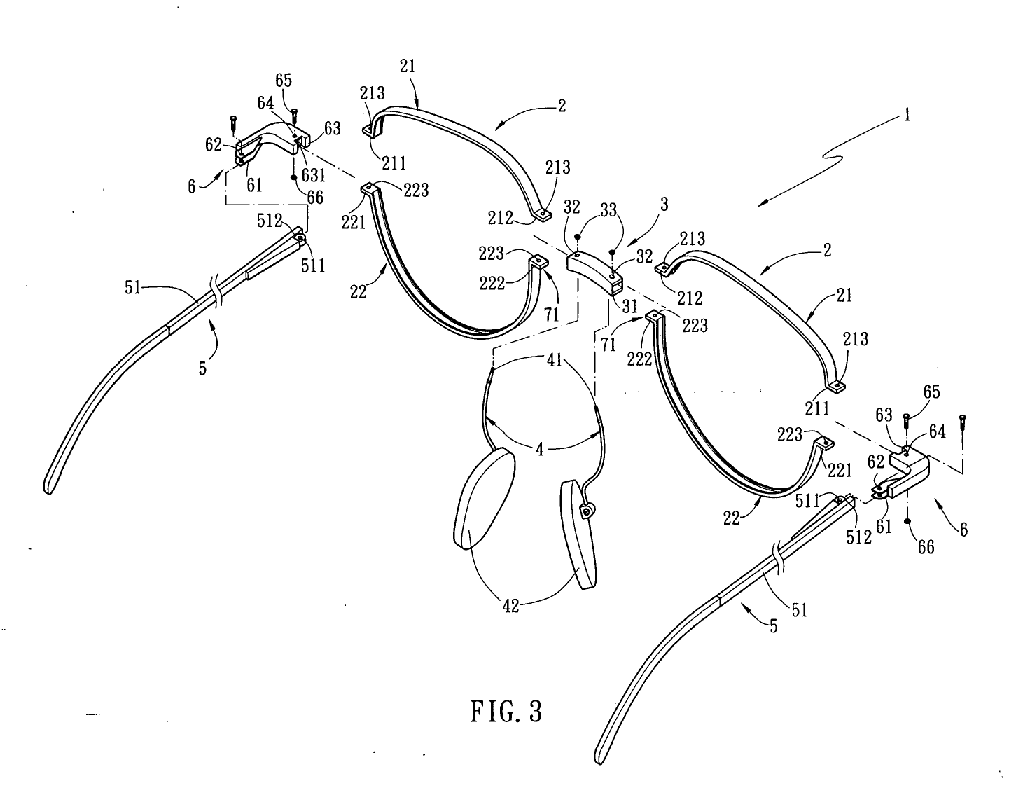

Refer to FIGS. 2 and 3 for a first embodiment of the composite frame of spectacles according to the invention. The spectacles frame 1 includes two fronts 2, a bridge 3 connecting the two fronts 2, a pair of nose brackets 4 connecting to a lower side of the bridge 3, two temples 5 each being pivotally coupled with a coupling module 6 connected to one end of the front 2 remote from the bridge 3. In this embodiment, each of the fronts 2 includes a upper rim 21 and a lower rim 22 that are separable. The upper rim 21 has a first opening which has two sides extended to form respectively a first pin 211 and 212 with a first aperture 213 formed thereon. The lower rim 22 has a second opening which has two sides extended to form respectively a second pin 221 and 222 with a second aperture 223 formed thereon. The bridge 3 has two transverse ends each having a first cavity 31 of a selected depth or running through two ends thereof. The bridge 3 further has a first bore 32 running downwards through the cavity 31 from the top side. Each of the nose brackets 4 has a longitudinal end forming a thread end 41 and an opposing end connecting to a nose pad 42. The temple 5 includes a stem 51 which has a first connection end 512 with a hole 511 formed thereon. The coupling module 6 has a second connection end 61 on a longitudinal distal end with a screw hole 62 formed thereon, and a transverse end 63 with a second cavity 631 formed thereon, and a second bore 64 running through the second cavity 631 from the top side of the transverse end 63.

Referring to FIGS. 2 and 3, the upper rim 21 and the lower rim 22 are coupled together on the opening side, and the first pin 212 and the second pin 222 on one side are coupled in a stacking manner. The coupled pins are inserted into the first cavity 31, and the thread end 41 of the nose bracket 4 runs through the first bore 32 of the bridge 3 through the second apertures 223 of the pins 212 and 222, and is coupled with a nut 33 so that the fronts 2, bridge 3 and the nose bracket 4 are coupled together. Moreover, the other first pin 211 and second pin 221 are coupled and inserted into the second cavity 631 of the transverse end 63 of the coupling module 6, and a fastening element such as a screw 65 or a pin runs through the second bore 64 and the first aperture 213 of the pins 211 and 221 to couple with a nut 66 so that the upper rim 21 and the lower rim 22 are coupled together through the coupling module 6. In addition, the first connection end 512 of the temple 5 is coupled with the second connection end 61 of the coupling module 6 in a conventional way to enable the second connection end 61 to be moved towards the front 2.

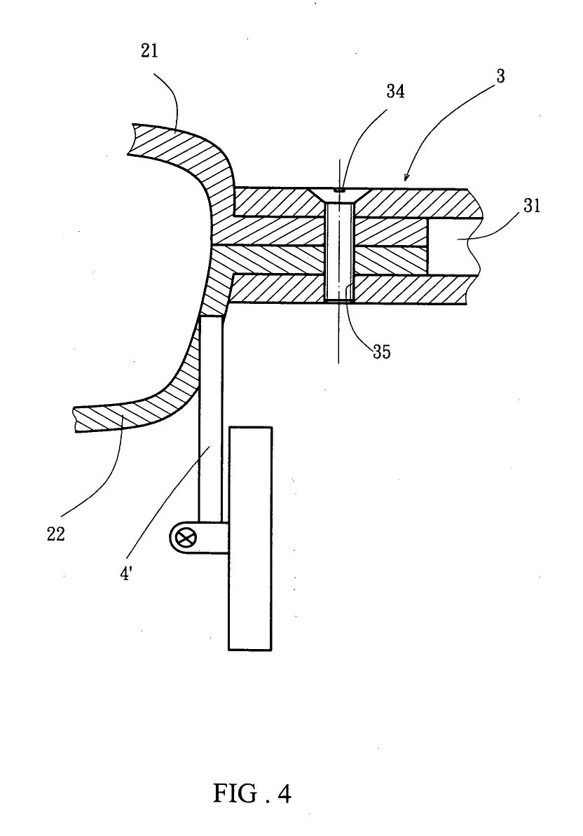

In the first embodiment, the thread end 41 of the nose bracket 4 runs through the upper rim 21, lower rim 22 and the bridge 3. However, in a second embodiment shown in FIG. 4, the nose bracket 4′ is directly fastened to the rim edge of the lower rim 22. While it looks like the conventional approach, the conventional front does not have the separable upper rim 21 and lower rim 22 as the invention does. Moreover, for directly fastening the nose bracket 4′ to the rim edge of the lower rim 22, the first bore 32 formed on the bridge 3 in the first embodiment may become a screw hole 35 to mate a screw 34.

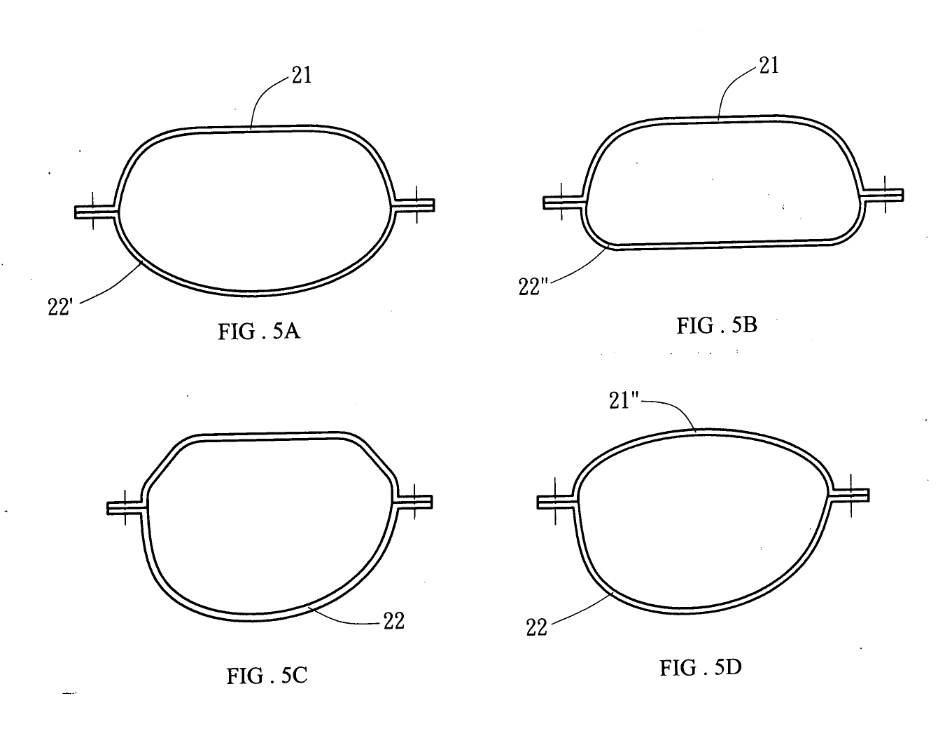

With the upper rim 21 and the lower rim 22 of the front 2 being separable, one upper rim 21 may be coupled and assembled with different types of lower rim 22′ and 22″ as shown in FIGS. 5A and 5B. And one lower rim 22 may also be coupled and assembled with different types of upper rim 21′ and 21″ as shown in FIGS. 5C and 5D. Hence based on a few basic upper rims 21 and lower rims 22, multiple styles of fronts 2 may be assembled and formed. In addition, the upper rim 21 and the lower rim 22 may be coated with different colors to enrich the color combination of the fronts. This is not possible in the conventional integrated fronts. Furthermore, in the event that damage or broken happens to the upper rim 21, lower rim 22, bridge 3 and coupling module 6, they may be disassembled and replaced individually at the general eyeglasses shop or by users in a DIY manner. The repairing task is simpler and may be done quickly.

The invention, by having the elements such as the fronts 2, bridge 3 and nose brackets 4 fabricated separately and assembled easily, not only reduces or even eliminates soldering, also makes fabrication process simpler, and repairs more convenient. In addition, different shapes or colors of the upper rim 21 and lower rim 22 may be coupled to form the fronts 2 so that various types of the spectacle frame 1 may be made at a lower production cost, and consumers can assemble and alter the frame style by themselves with more satisfaction.

While the preferred embodiments of the invention have been set forth for the purpose of disclosure, modifications of the disclosed embodiments of the invention as well as other embodiment thereof may occur to those skilled in the art. The embodiments set forth above serve only for illustrative purpose, and are not the limitation of the invention. For instance, the upper rim 21 and the lower rim 22 may be integrally formed like a conventional front but with the first pins 211 and 212 extended transversely as shown in FIG. 3 to be inserted into the first bore 32 of the bridge 3 to facilitate assembly and repairs. Moreover, coupling of the first pins 211 and 212 with the bridge 3 and coupling module 6 may be accomplished through screws or pins. Or a tight coupling may also be formed between the pins 211, 212, 221 and 222 and the bridge 3 and the coupling module 6. Or two elements to be coupled may be formed in a male and a female that mate each other. Accordingly, the appended claims are intended to cover all embodiments which do not depart from the spirit and scope of the invention.

I claim:

1. A composite frame for spectacles, comprising:
two fronts each having a first pin and a second pin extended transversely from two sides thereof;
a bridge having two transverse ends each having a first cavity to hold a first pin;
a pair of nose brackets each having a longitudinal end running through the bridge and the first pin held therein to couple the front and the bridge; and
two coupling modules each having a longitudinal connection end for coupling with a temple of the spectacle frame and a transverse end having a second cavity for holding the second pin.

2. The composite frame for spectacles of claim 1, wherein the first cavity on the two transverse ends of the bridge is a through hole.

3. The composite frame for spectacles of claim 1, wherein the first cavity on the two transverses ends of the bridge has an opening opposite to each other.

4. The composite frame for spectacles of claim 1, wherein the longitudinal end of each nose bracket is a thread end.

5. The composite frame for spectacles of claim 1, wherein the first pin and the second pin have respectively an aperture.

6. The composite frame for spectacles of claim 1, wherein the coupling module has a second bore running through thereof and the second cavity.

7. The composite frame for spectacles of claim 6, wherein the second bore of the coupling module receives a fastening element to couple the second pin on the coupling module.

8. The composite frame for spectacles of claim 7, wherein the fastening element is a screw.

9. The composite frame for spectacles of claim 7, wherein the fastening element is a pin.

10. The composite frame for spectacles of claim 1, wherein the first pin and the second pin are inserted respectively into the bridge and the coupling modules.

11. The composite frame for spectacles of claim 1, wherein each of the fronts includes a upper rim and a lower rim that are separable and have respectively an opening which has two sides extended to form the first pin and the second pin.

12. The composite frame for spectacles of claim 11, wherein the upper rim and the lower rim are coupled and stacked together for inserting into the bridge and the coupling modules.
